(19) United States
(12) Patent Application Publication
(10) Pub. No.: US 2010/0020014 A1
(43) Pub. Date: Jan. 28, 2010

(54) WIRELESS MOUSE WITH POWER GENERATING FUNCTION

(75) Inventor: I-THUN LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/488,548

(22) Filed: Jun. 20, 2009

(30) Foreign Application Priority Data
Jul. 25, 2008 (CN) 200810303084.0

(51) Int. Cl. G09G 5/08

(52) U.S. Cl. 345/163

(57) ABSTRACT

A wireless mouse includes a bottom board, a pressable button, a transmission gear device, a power-generator and a power storage device. The pressable button comprises a connecting end and a free end, the connecting end rotatably connected to the bottom board, the free end capable of being pressed by an outer force to move from a first position to a second position to generate a rotation kinetic energy. The transmission gear device rotatably connects to the pressable button and is configured for transferring the rotation kinetic energy generated by the moving of the pressable button. The power-generator converts the rotation kinetic energy into an electrical energy. The power storage device is electrically coupled to the power-generator and configured for storing the electrical energy converted by the power-generator and supplying power for the wireless mouse.

### BACKGROUND

1. Technical Field

The present disclosure relates to wireless mice, and particularly to a wireless mouse with a power generating function.

2. Description of Related Art

A mouse may be wired or wirelessly connected to a host such as a personal computer. In the case of the wired mouse, the mouse is powered by the host via a cable. However, because the mouse is tethered to the host by the cable, the range of movement of the mouse is limited. In the case of a wireless mouse, a battery is used to power the wireless mouse. However, frequent replacement of the battery is inconvenient and also not cost efficient. Moreover, disposing of the battery may not be environmentally friendly.

Therefore, what is needed is to provide a mouse, in which the above problems are eliminated or at least alleviated.

### BRIEF DESCRIPTION OF THE DRAWINGS

FIG. 1 is a partially schematic view of a wireless mouse including a pressable button in a first position, according to an exemplary embodiment.

FIG. 2 is similar to FIG. 1, but showing the pressable button in a second position.

### DETAILED DESCRIPTION

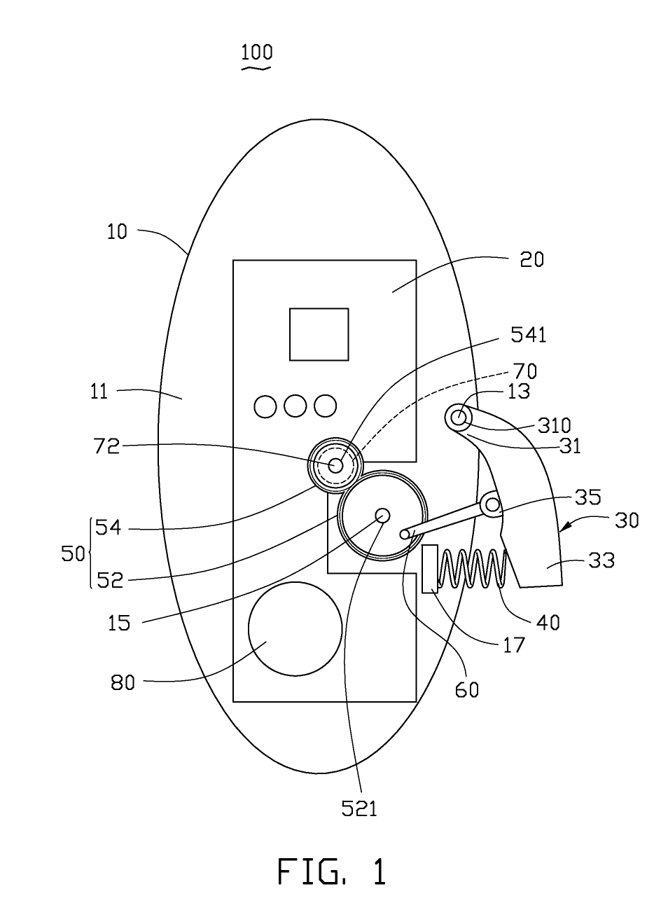

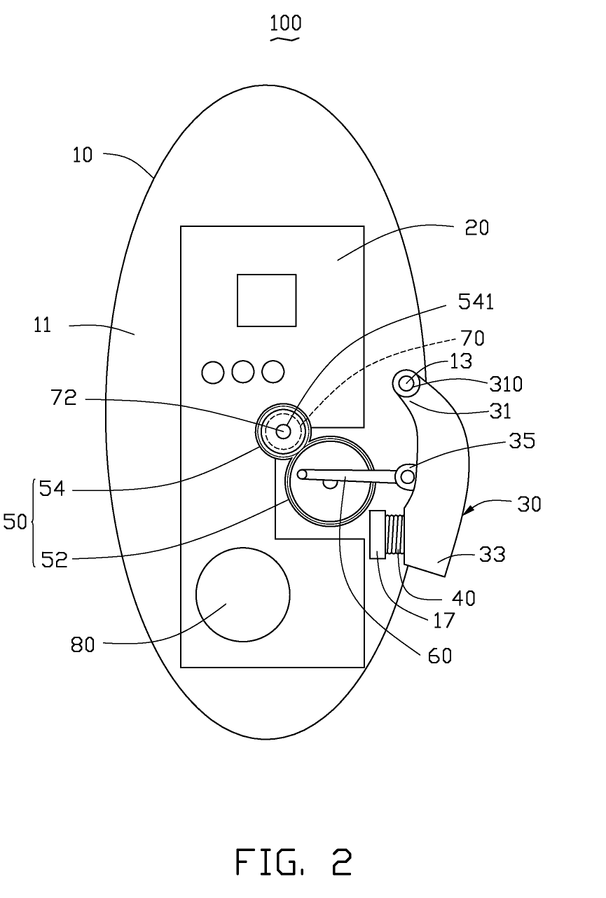

Referring to FIG. 1 and FIG. 2, a wireless mouse 100, according to an exemplary embodiment, includes a housing 10, a circuit board 20, a pressable button 30, an elastic member 40, a transmission gear device 50, a connecting rod 60, a power-generator 70 and a power storage device 80. The circuit board 20, the pressable button 30, the elastic member 40, the transmission gear device 50, the connecting rod 60, the power-generator 70 and the power stage device 80 are all accommodated in the housing 10.

The housing 10 includes a bottom board 11 and a first fixing rod 13, a second fixing rod 15 and a fixing block 17. The first fixing rod 13, the second fixing rod 15 and the fixing block 17 are all substantially perpendicularly extended from the bottom board 11.

The circuit board 20 is mounted on the bottom board 11 of the housing 10. In the present embodiment, the circuit board 20 is a printed circuit board.

The pressable button 30 includes a connecting end 31 and a free end 33. A first hole 310 is defined through the connecting end 31. The pressable button 30 is rotatably connected with the first fixing rod 13 via the first fixing rod 13 rotatably extending though the first hole 310 defined in the connecting end 31 of the pressable button 30. The free end 33 protrudes out of the housing 10 for a user to press conveniently. Thus, the pressable button 30 can generate a rotation kinetic energy when pressed by the user. A protruding block 35 is formed extending from a middle portion of the pressable button 30 between the connecting end 31 and the free end 33 for rotatably connected with the connecting rod 60. Thereby, the pressable button 30 transmits the rotation kinetic energy to the connecting rod 60.

The elastic member 40 includes two ends. One end of the elastic member 40 is fixed on the fixing block 17 and the other end of the elastic member 40 is fixed on the free end 33 of the pressable button 30. In the present embodiment, the elastic member 40 is a compression coil spring.

The transmission gear device 50 is configured for transferring the rotation kinetic energy of the connecting rod 60 to the power-generator 70. The transmission gear device 50 includes a first transmission gear 52 and a second transmission gear 54 meshing with the first transmission gear 52. The first transmission gear 52 is mounted on the bottom board 20 and the second transmission gear 54 is mounted on the power-generator 70. A total number of teeth of the first transmission gear 52 is greater than that of the second transmission gear 54. Thereby a rotating speed of the second transmission gear 54 is faster than that of the first transmission gear 52. The first transmission gear 52 defines a first central hole 521 for rotatably receiving the second fixing rod 15. Thus, the first transmission gear 52 rotates about the second fixing rod 15. A second central hole 541 is defined through the second transmission gear 54.

The connecting rod 60 includes two ends. One end of the connecting rod 60 is rotatably connected with the protruding block 35 of the pressable button 30. The other end of the connecting rod 60 is fixed on the first transmission gear 52 to drive the first transmission gear 52 to rotate. Such that, the transmission gear device 50 is rotatably connected to the pressable button 30 via the connecting rod 60, and can be driven by the pressable button 30 to rotate when the free end 33 of the pressable button 30 is pressed to move from the first position (See FIG. 1) to the second position (See FIG. 2) to transmit the rotation kinetic energy of the connecting rod 60 to the power-generator 70.

The power-generator 70 is configured for converting the rotation kinetic energy transferred from the transmission gear device 50 into an electrical energy. The power-generator 70 includes a rotatable rod 72. The rotatable rod 72 is fixedly received in the second central hole 541 of the second transmission gear 54. Thus, the rotatable rod 72 rotates with the second transmission gear 54, and the power-generator 70 converts the kinetic energy transferred from the rotatable rod 72 into the electrical energy.

The power storage device 80 is electrically coupled to the power-generator 70 via the circuit board 20 and configured for storing the electrical energy converted by the power-generator 70, and supplying the electrical energy for the wireless mouse 100 to work. The power storage device 80 is a rechargeable battery.

In use, when the free end 33 is pressed by a user to move from the first position (see FIG. 1) to the second position (see FIG. 2), the elastic member 40 is compressed and the connecting rod 60 is pushed by the pressable button 30. Then, the transmission gear 50 is driven by the connecting rod 60 to further rotate the power-generator 70. Thus, the rotation kinetic energy generated by the moving of the pressable button 30 is transferred to the power-generator 70 via the connecting rod 60, to be converted into the electrical energy and stored in the power storage device 80 for supplying power for the wireless mouse 100. When the force applied to the free end 33 disappears, the elastic member 40 restores and the elastic member 40 pushes the free end 33 together with the connecting rod 60 to move from the second position to the first position.

In all, the wireless mouse can convert the rotation of the pressable button 30 into electrical energy. Therefore, frequent replacement of the power storage device 80 can be avoided, and a longtime use of the power storage device 80 is achieved, which is environmentally friendly.

It is to be understood, however, that even though numerous has been described with reference to particular embodiments, but the present invention is not limited to the particular embodiments described and exemplified, and the embodiments are capable of considerable variation and modification without departure from the scope of the appended claims.

What is claimed is:

1. A wireless mouse comprising:
a bottom board;
a pressable button comprising a connecting end and a free end, the connecting end rotatably connected to the bottom board, the free end capable of being pressed by an outer force to move from a first position to a second position to generate a rotation kinetic energy;
a transmission gear device rotatably connected to the pressable button and configured for transferring the rotation kinetic energy generated by the moving of the pressable button to a power-generator to convert the rotation kinetic energy into an electrical energy; and
a power storage device electrically coupled to the power-generator and configured for storing the electrical energy converted by the power-generator and supplying power for the wireless mouse.

2. The wireless mouse of claim 1, further comprising an elastic member connected the free end to the bottom board to drive the free end to move from the first position to the second position.

3. The wireless mouse of claim 2, further comprising a fixing block substantially perpendicularly extending from the bottom board to be operable to connect to the elastic member.

4. The wireless mouse of claim 2, wherein the elastic member includes a compression coil spring.

5. The wireless mouse of claim 1, wherein the transmission gear device comprises a first transmission gear mounted on the bottom board and a second transmission gear mounted on the power-generator and meshed with the first transmission gear.

6. The wireless mouse of claim 5, wherein a total number of teeth of the first transmission gear is greater than that of the second transmission gear.

7. The wireless mouse of claim 5, further comprising a connecting rod comprising two ends, one end of the connecting rod rotatably connected with the pressable button to receive the rotation kinetic energy generated by the pressable key, the other end of the connecting rod fixing on the first transmission gear to drive the first transmission gear to rotate.

8. The wireless mouse of claim 1, further comprising a fixing rod substantially perpendicularly extending from the bottom board and rotatably connected to the connecting end of the pressable button.

9. The wireless mouse of claim 5, further comprising a fixing rod substantially perpendicularly extending from the bottom board and rotatably received in a central hole defined in the first transmission gear.

10. The wireless mouse of claim 5, wherein the power-generator comprises a rotatable rod and rotatably received in a central hole defined through the second transmission gear for making the power-generator capable of being driven to rotate by the second transmission gear.

11. The wireless mouse of claim 7, wherein the pressable button comprises a protruding block formed extending from a middle portion of the pressable button between the connecting end and the free end for rotatably connected to the connecting rod.

12. The wireless mouse of claim 1, further comprising a housing receiving the bottom board, the pressable button, the transmission gear device, the power-generator, the power storage device therein, the free end of the pressable button protruding out of the housing for a user to press.

13. The wireless mouse of claim 1, wherein the power storage device is a rechargeable battery.

14. The wireless mouse of claim 1, further comprising a circuit board mounted on the bottom board, and the power-generator and the power storage device are electrically coupled to each other via the circuit board.

15. The wireless mouse of claim 14, wherein the circuit board is a printed circuit board.
